(19) United States
(12) Patent Application Publication
(10) Pub. No.: US 2005/0212478 A1
(43) Pub. Date: Sep. 29, 2005

(54) Station for self-propelled robot

(75) Inventor: Hiroyuki Takenaka, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/087,445

(22) Filed: Mar. 23, 2005

(30) Foreign Application Priority Data
Mar. 25, 2004 (JP) JP2004-090071

(51) Int. Cl. H02J 7/00

(52) U.S. Cl. 320/107; 318/587

(57) ABSTRACT

A control unit of a station concentrically rotates a plurality of unit replacing units by a motor on a first horizontal plane parallel to a floor bearing the station when arrival of the self-propelled cleaner is detected. The control unit activates, as a unit for removing an old battery unit from the self-propelled cleaner, the unit replacing unit included among the plurality of unit replacing units and opposed to the self-propelled cleaner located on the station. After the old battery unit is removed from the self-propelled cleaner, the control unit activates the motor. By the rotation of this motor, another unit replacing unit opposed to the self-propelled cleaner is activated as a unit for attaching a new battery unit to the self-propelled cleaner instead of the unit replacing unit previously activated as the removing unit.

### BACKGROUND OF THE INVENTION

1. Field of the Invention

The present invention relates to a station for a self-propelled robot, and particularly to a station having a function of charging a battery for the self-propelled robot.

2. Description of the Background Art

In mobile work robots having a moving function for movement and a work function for cleaning or the like, power for driving primarily depend on internal batteries. Conventionally, charging of such batteries is performed manually, or is performed in such a manner that the mobile work robot moves to an independent station, and the battery is automatically charged by the station (see patent references 1-4).
Patent Reference 1: Japanese Patent Gazette No. 2001-525567
Patent Reference 2: Japanese Patent Laying-Open No. 02-107219
Patent Reference 3: Japanese Patent Gazette No. 10-502274
Patent Reference 4: Japanese Patent Laying-Open No. 2002-345706

According to the techniques disclosed in the above patent references 1-4, the mobile work robot is automatically charged. During the charging, however, the robot can neither move nor work, and thus the robot is in a non-operating status so that an availability factor lowers.

### SUMMARY OF THE INVENTION

An object of the invention is to provide a station for a self-propelled robot, and particularly a station, which allows operation of the self-propelled robot with a high availability factor.

For achieving the above object, a station for a self-propelled robot with a moving unit for movement according to an aspect of the invention includes an arrival detecting unit detecting arrival of the self-propelled robot at the station, and a battery replacing unit. The battery replacing unit replaces a removable battery unit supplying an electric power to various portions in the self-propelled robot with a charged battery unit prepared in advanced when the arrival detecting unit detects arrival of the self-propelled robot.

Accordingly, when the arrival detecting unit detects arrival of the self-propelled robot, the battery replacing unit in the station replaces the removable battery unit of the self-propelled robot with the charged battery unit prepared in advance.

Since the battery unit of the self-propelled robot is refreshed by the replacement with the charged battery unit prepared in advance, such a situation is prevented that the self-propelled robot is in a non-operating state during a charging period. This improves the availability factor of the self-propelled robot.

Preferably, the battery replacing unit has a battery removing unit for removing the battery unit from the self-propelled robot located on the station, a battery attaching unit attaching the charged battery unit to the self-propelled robot after the battery unit was removed, and a battery replacement control unit selectively activating the battery removing unit and the battery attaching unit.

Accordingly, when the battery removing unit removes the battery from the self-propelled robot, the battery attaching unit is then activated instead of the battery removing unit to attach the battery, which is already charged, to the self-propelled robot. In this manner, the battery is exchanged between the self-propelled robot and the station.

Preferably, the battery replacing unit further includes a battery mount unit holding the battery unit, and a charging unit charging the battery unit held by the battery mount unit. The battery mount unit holds the battery unit removed from the self-propelled robot by the battery removing unit. The battery attaching unit attaches the battery unit, which was charged by the charging unit when it was held by the battery mount unit, to the self-propelled robot.

Therefore, the battery unit attached to the self-propelled robot can be reused so that one station can charge the plurality of self-propelled robots by replacing the battery units, or can change the same self-propelled robot multiple times by replacing the battery units.

Preferably, the station further includes a battery replacing rotary unit rotating to rotate concentrically the plurality of battery replacing units on a first horizontal plane parallel to a floor surface bearing the station. The battery replacement control unit includes a battery removal activating unit and a battery attachment activating unit. The battery removal activating unit activates, as the battery removing unit, the battery replacing unit included among the plurality of battery replacing units and opposed to the self-propelled robot located on the station. The battery attachment activating unit activates the battery attaching unit of the battery replacing unit located in the position opposed to the self-propelled robot by rotation of the battery replacing rotary unit after the battery removal activating unit activates the battery replacing unit.

Accordingly, the battery replacing rotary unit concentrically rotates the plurality of battery replacing units to locate one of the battery replacing units in the position opposed to the self-propelled robot which arrived at the station, and this one battery replacing unit removes the battery. Thereafter, the charged battery can be attached to the self-propelled robot by another battery replacing unit, which is located in the above opposed position by the rotation of the battery replacing rotary unit in stead of the above one battery replacing unit.

Therefore, removal of the used battery from the self-propelled robot and attachment of the charged battery to the self-propelled robot can be easily performed by concentrically rotating the plurality of battery replacing units.

Preferably, the self-propelled robot further includes a cleaning unit having a dust collecting function, and a removable dust storage unit storing the dust collected by the cleaning unit. The station further includes a dust storage unit replacing unit replacing the dust storage unit of the self-propelled robot located on the station with a cleaned dust storage unit prepared in advance.

Therefore, when the self-propelled robot arrives at the station, the dust storage unit replacing unit replaces the removal dust storage unit of the self-propelled robot with the cleaned dust storage unit prepared in advance.

Accordingly, since the dust storage unit of the self-propelled robot is replaced with the cleaned dust storage unit prepared in advance, such a situation can be avoided that the self-propelled robot is in the non-operating state for a period of cleaning of the dust storage unit. This improves the availability factor of the self-propelled robot.

Preferably, the dust storage unit replacing unit has a dust storage unit removing unit removing the dust storage unit from the self-propelled robot located on the station, a dust storage unit attaching unit attaching the cleaned dust storage unit to the self-propelled robot not carrying the dust storage unit, and a dust storage unit replacement control unit selectively activating the dust storage unit removing unit and the dust storage unit attaching unit.

Therefore, the dust storage unit removing unit removes the dust storage unit from the self-propelled robot, and then the dust storage unit attaching unit, which is activated instead of the dust storage unit removing unit, attaches the cleaned dust storage unit to the self-propelled robot.

Preferably, the dust storage unit replacing unit further has a dust storage unit mount unit holding the dust storage unit, and a cleaning unit cleaning the dust storage unit held by the dust storage unit mount unit. When the dust storage unit mount unit holds the dust storage unit removed by the dust storage unit removing unit from the self-propelled robot, the dust storage unit attaching unit attaches the dust storage unit already cleaned by the cleaning unit, which is held by the dust storage unit mount unit, to the self-propelled robot.

Therefore, the dust storage unit removed from the self-propelled robot can be reused in such a manner that the removed dust storage unit is cleaned by the cleaning unit on the station, and then is attached to the self-propelled robot. Thereby, the one station can perform the replacement of the dust storage units for the plurality of self-propelled robots, and can repetitively perform the replacement of the dust storage units on the self-propelled robot.

Preferably, the station further includes a dust storage unit replacing rotary unit rotating to rotate concentrically the plurality of dust storage unit replacing units on a second horizontal plane parallel to a floor surface bearing the station. The dust storage unit replacement control unit includes a dust storage unit removal activating unit and a dust storage unit attachment activating unit. The dust storage unit removal activating unit activates, as the dust storage unit removing unit, the dust storage unit replacing unit included among the plurality of dust storage unit replacing units and opposed to the self-propelled robot located on the station. The dust storage unit attachment activating unit activates the dust storage unit attaching unit of the dust storage unit replacing unit located in the position opposed to the self-propelled robot by rotation of the dust storage unit replacing rotary unit after the dust storage unit removal activating unit activates the dust storage unit replacing unit.

Accordingly, the dust storage unit replacing rotary unit concentrically rotates the plurality of dust storage unit replacing units to locate one of the dust storage unit replacing units in the position opposed to the self-propelled robot which arrived at the station, and this one dust storage unit replacing unit removes the dust storage unit. Thereafter, the cleaned dust storage unit is attached to the self-propelled robot by another dust storage unit replacing unit, which is located in the above opposed position by the rotation of the dust storage unit replacing rotary unit in stead of the above one dust storage unit replacing unit.

Therefore, removal of the dust storage unit from the self-propelled robot and attachment of the cleaned dust storage unit to the self-propelled robot can be easily performed by concentrically rotating the plurality of dust storage unit replacing units.

Preferably, the first and second horizontal planes are different from each other. Since the first horizontal plane, on which the plurality of battery replacing units concentrically rotate, is different from the second horizontal plane, on which the plurality of dust storage unit replacing units concentrically rotate, the station can replace the dust storage unit and the battery unit even when the dust storage unit and the battery unit attached to the self-propelled robot are located at different heights from the floor, respectively.

Preferably, the first horizontal plane is the same as the second horizontal plane. Since the first horizontal plane, on which the plurality of battery replacing units concentrically rotate, is the same as the second horizontal plane, on which the plurality of dust storage unit replacing units concentrically rotate, the station can replace the dust storage unit and the battery unit even when the dust storage unit and the battery unit attached to the self-propelled robot are located at the same height from the floor.

Preferably, the replacement of the battery unit by the battery replacing unit is performed in parallel with the replacement of the dust storage unit by the dust storage unit replacing unit. Therefore, the replacement of the battery unit with the charged battery unit and the replacement of the dust storage unit with the cleaned dust storage unit can be performed on the self-propelled robot within a short time.

For achieving the foregoing object, a station for a self-propelled robot according to another aspect of the invention has the following features.

The self-propelled robot includes a moving unit for movement, and a removable battery unit supplying an electric power to various portions of the self-propelled robot.

The station includes an arrival detecting unit detecting arrival of the self-propelled robot at the station, and a battery replacing unit replacing a removable battery unit of the self-propelled robot with a charged battery unit prepared in advanced when the arrival detecting unit detects arrival of the self-propelled robot.

The battery replacing unit has a battery removing unit for removing the battery unit from the self-propelled robot located on the station, a battery attaching unit attaching the charged battery unit to the self-propelled robot after the battery unit was removed, and a battery replacement control unit selectively activating the battery removing unit and the battery attaching unit.

The battery replacing unit further includes a battery mount unit holding a battery unit, and a charging unit charging the battery unit held by the battery mount unit. The battery mount unit holds the battery unit removed from the self-propelled robot by the battery removing unit. The battery attaching unit attaches the battery unit, which was charged by the charging unit when it was held by the battery mount unit, to the self-propelled robot.

The station further includes a battery replacing rotary unit rotating to rotate concentrically the plurality of battery replacing units on a first horizontal plane parallel to a floor surface bearing the station. The battery replacement control unit includes a battery removal activating unit and a battery attachment activating unit. The battery removal activating unit activates, as the battery removing unit, the battery replacing unit included among the plurality of battery replacing units and opposed to the self-propelled robot located on the station. The battery attachment activating unit activates the battery attaching unit of the battery replacing unit located in the position opposed to the self-propelled robot by rotation of the battery replacing rotary unit after the battery removal activating unit activates the battery replacing unit.

The self-propelled robot further includes a cleaning unit having a dust collecting function, and a removable dust storage unit storing the dust collected by the cleaning unit. The station further includes a dust storage unit replacing unit replacing the dust storage unit of the self-propelled robot located on the station with a cleaned dust storage unit prepared in advance. The dust storage unit replacing unit has a dust storage unit removing unit removing the dust storage unit from the self-propelled robot located on the station, a dust storage unit attaching unit attaching the cleaned dust storage unit to the self-propelled robot not carrying the dust storage unit, and a dust storage unit replacement control unit selectively activating the dust storage unit removing unit and the dust storage unit attaching unit.

The dust storage unit replacing unit further has a dust storage unit mount unit holding the dust storage unit, and a cleaning unit cleaning the dust storage unit held by the dust storage unit mount unit. The dust storage unit mount unit holds the dust storage unit removed by the dust storage unit removing unit from the self-propelled robot. The dust storage unit attaching unit attaches the dust storage unit already cleaned by the cleaning unit, which is held by the dust storage unit mount unit, to the self-propelled robot.

The station further includes a dust storage unit replacing rotary unit rotating to rotate concentrically the plurality of dust storage unit replacing units on a second horizontal plane parallel to a floor surface bearing the station. The dust storage unit replacement control unit includes a dust storage unit removal activating unit and a dust storage unit attachment activating unit.

The dust storage unit removal activating unit activates, as the dust storage unit removing unit, the dust storage unit replacing unit included among the plurality of dust storage unit replacing units and opposed to the self-propelled robot located on the station. The dust storage unit attachment activating unit rotates the dust storage unit replacing rotary unit after the dust storage unit removal activating unit activates the dust storage unit replacing unit. The dust storage unit attachment activating unit activates the dust storage unit attaching unit of the dust storage unit replacing unit located in the position opposed to the self-propelled robot by this rotation.

The battery replacing unit replaces the battery unit in parallel with the replacement of the dust storage unit by the dust storage unit replacing unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view showing a state of exchanging a unit between a station and a self-propelled robot according to an embodiment of the invention.

FIG. 2 is a top view.

FIG. 3 shows a structure for replacing a unit according to the embodiment of the invention.

FIG. 4 is a block diagram illustrating a structure of the station according to the embodiment of the invention.

FIG. 5 is a block diagram illustrating a structure of the self-propelled cleaner according to the embodiment of the invention.

FIG. 6 is a flowchart illustrating processing performed for unit replacement on the station according to the embodiment of the invention.

### DESCRIPTION OF THE PREFERRED EMBODIMENTS

Embodiments of the invention will now be described with reference to the drawings. As an example of a self-propelled robot, the following description will be given on a mobile work robot, which is a self-propelled cleaner having a moving unit for moving the cleaner itself as well as a cleaning function as a kind of a work function, although the work function is not restricted to the cleaning function.

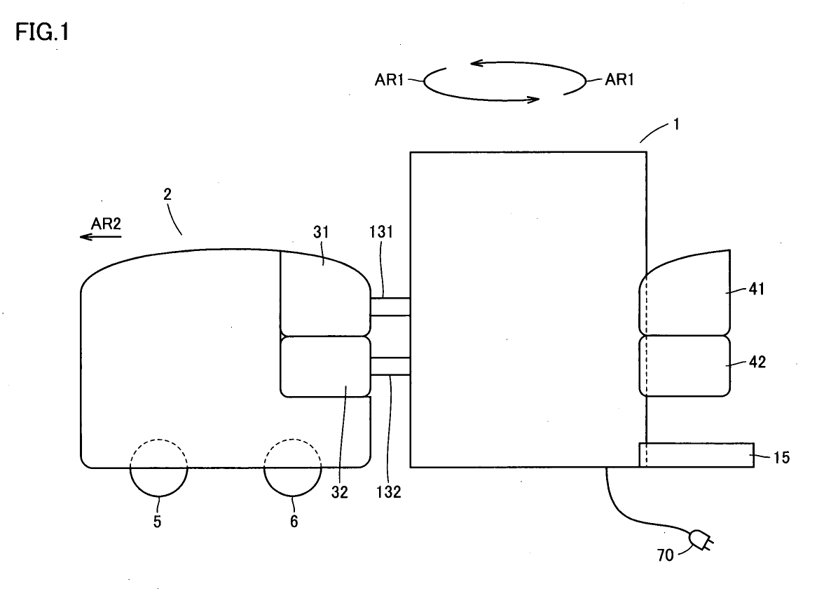

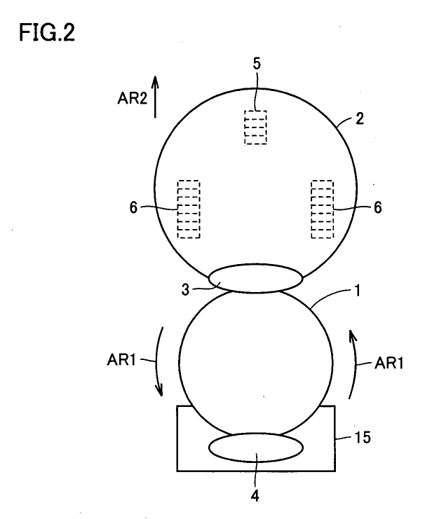

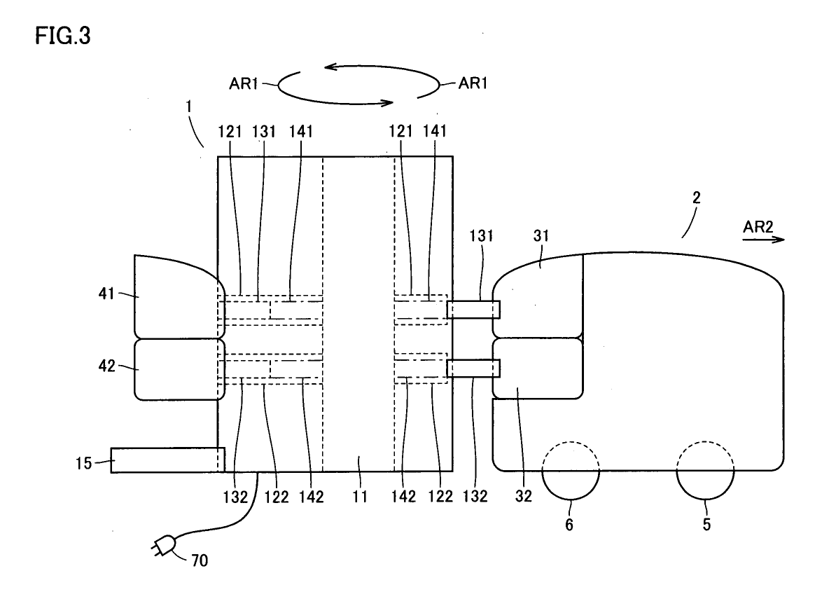

Referring to FIGS. 1 and 2, a mobile work robot system according to the embodiment includes a station 1 and one or more self-propelled cleaner 2. This system replaces an old battery unit 31 and an old dust bag 32 of self-propelled cleaner 2 with a new battery unit 41 and a new dust bag 42 without dust held on station 1. A function of this replacement will be described later with reference to FIG. 3.

Self-propelled cleaner 2 includes front and rear wheels 5 and 6 for a moving function. Station 1 has a function of charging old battery unit 31 replaced with new battery unit 41, and also has a function of disposing of the dust of old dust bag 32 replaced with new dust bag 42. The dust in old dust bag 32 is thrown away into a dust storage unit 15 attached integrally to station 1. Dust storage unit 15 is a container having a function of receiving and storing the dust discharged from old dust bag 32. The dust in dust storage unit is thrown away by user.

Station 1 has a line cord plug 70, which can be inserted into a receptacle of a commercial power (not shown), for preparing new battery unit 41 by charging old battery unit 31, and for supplying a power to various portions in station 1.

When old battery unit 31 and old dust bag 32 are replaced with the new ones, self-propelled cleaner 2 starts movement in a direction of an arrow AR2. In FIG. 2, old battery unit 31 and old dust bag 32 of self-propelled cleaner 2 are represented as a cleaner-side unit 3, and new battery unit 41 and new dust bag 42 on station 1 are represented as a station-side unit 4.

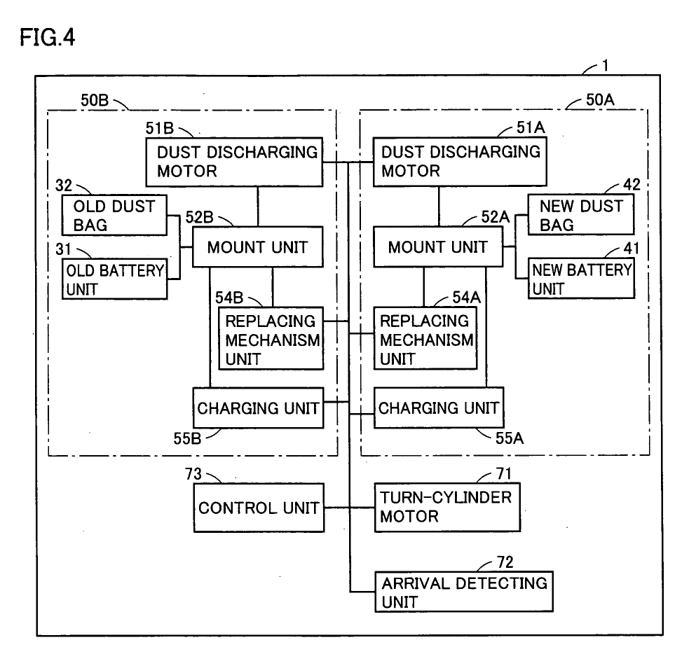

Referring to FIG. 4, station 1 includes a control unit 73 including a microcomputer for concentratedly controlling and monitoring station 1 itself, a turn-cylinder motor 71, i.e., motor for turning and driving a cylinder 11, which will be described later, under control of control unit 73, an arrival detecting unit 72 for detecting arrival of self-propelled cleaner 2 at station 1, and a plurality of unit replacing units. For the sake of simplicity, only two unit replacing units 50A and 50B will be described, but three or more unit replacing units may be employed. FIG. 4 shows a state, in which unit replacing unit 50B carries discharged old battery unit 31 and dust-filled old dust bag 32, which are removed from self-propelled cleaner 2. Before old battery unit 31 and old dust bag 32 are removed from self-propelled cleaner 2, old battery unit 31 and old dust bag 32 are not present on station 1. Unit replacing units 50A and 50B have structures, which will be described later.

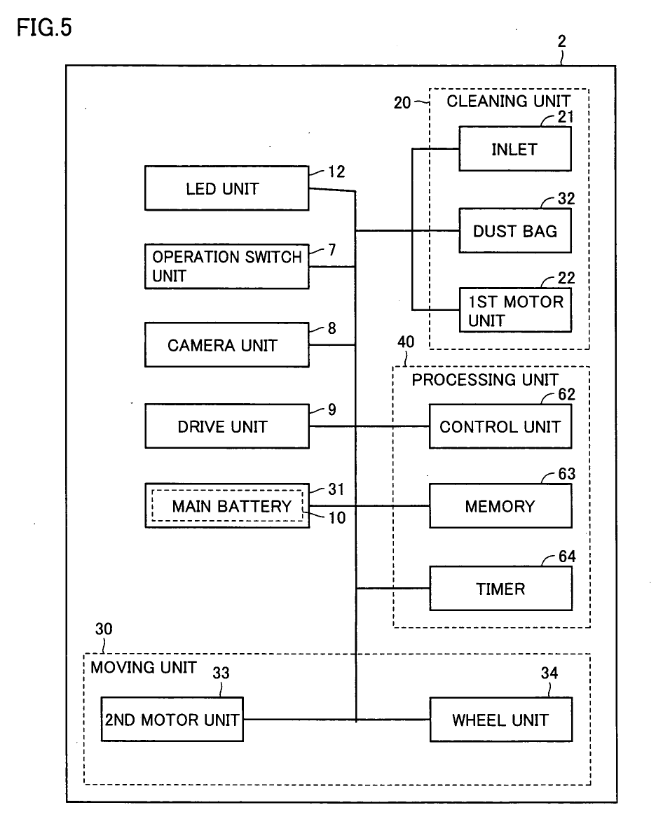

Referring to FIG. 5, self-propelled cleaner 2 includes a LED (Light Emitting Diode) unit 12 for notifying of a state of operation and others with light, an operation switch unit 7, which is operated by a user for entering various instructions controlling the operation of self-propelled cleaner 2, a camera unit 8 for a security function, a drive unit 9 for driving self-propelled cleaner 2, battery unit 31 including a rechargeable main battery 10 for supplying an operation power to various portions, a cleaning unit 20 functioning as a work unit, a moving unit 30 for movement and a processing unit 40. Battery unit 31 is removably attached to self-propelled cleaner 2.

Cleaning unit 20 has an inlet 21 for sucking in dust on a floor, a first motor unit 22, which produces a vacuum or low pressure portion communicated with inlet 21 for sucking dust from inlet 21, and dust bag 32 for receiving and storing the dust or the like thus sucked.

Moving unit 30 has a wheel unit 34 having a plurality of rotary wheels for movement, and a second motor unit 33 for rotating the wheels of wheel unit 34.

Processing unit 40 has a control unit 62 formed of a microcomputer and others for concentratedly controlling and monitoring self-propelled cleaner 2 itself, a memory 63 storing various data and programs, and a timer 64 for time measurement.

The exchange of the battery unit and dust bag between self-propelled cleaner 2 and station 1 is performed when control unit 62 detects a predetermined level of remaining power of main battery 10, or detects a predetermined amount level of dust in dust bag 32 with a sensor (not shown) or the like. When the unit and bag are to be replaced, control unit 62 determines a direction of station 1 based on image data, which is obtained and provided thereto by camera unit 8, and controls moving unit 30 to move self-propelled cleaner 2 in the determined direction. Thereby, self-propelled cleaner 2 starts movement toward station 1. The manner of determining the direction of station 1 is not restricted to the manner using the image data.

Arrival detecting unit 72 detects the arrival of self-propelled cleaner 2 at the position, where the battery unit and the dust bag can be exchanged between self-propelled cleaner 2 and station 1, e.g., in the following manners. Arrival detecting unit 72 detects with an ultrasonic sensor that a distance to self-propelled cleaner 2 decreases to or below a predetermined distance. Alternatively, the arrival is detected by detecting the fact that a magnetic level represents the arrival of self-propelled cleaner 2 at the position allowing the replacement, or that no difference is present in state of detection of the earth's magnetic field between the body of self-propelled cleaner 2 and station 1. The position detection utilizing the above magnetic field and earth's magnetic field is performed in a known manner, and therefore, description thereof is not given. On the station side, a guide groove may be arranged for self-propelled cleaner 2, and the arrival can be detected, e.g., when a sensor in the guide groove detects the fact that wheels 5 or 6 of self-propelled cleaner 2 are fitted into the guide groove.

Unit replacing units 50A and 50B have substantially the same structures and function. Unit replacing unit 50A has a dust discharging motor 51A, a mount unit 52A mounting (i.e., carrying and holding) new dust bag 42 and new battery unit 41, a replacing mechanism unit 54A associated to mount unit 52A, and a charging unit 55A charging the battery of the battery unit mounted on mount unit 52A with a commercial power supplied via plug 70. Unit replacing unit 50B has a dust discharging motor 51B, a mount unit 52B mounting old dust bag 32 and old battery unit 31, a replacing mechanism unit 54B, and a charging unit 55B charging the battery of the battery unit mounted on mount unit 52B.

The structures and functions of mount units 52A and 52B shown in FIG. 4 will be described with reference to FIG. 3. Mount unit 52A has cylinders 121 and 122 accommodating pistons 141 and 142, of which ends on one side are connected to arms 131 and 132, respectively, for mounting new dust bag 42 and new battery unit 41. Likewise, mount unit 52B has cylinders 121 and 122 accommodating pistons 141 and 142, of which ends on one side are connected to arms 131 and 132, respectively, for mounting old dust bag 32 and old battery unit 31. Arm 131 is provided for removing and attaching the battery unit, and arm 132 is provided for removing and attaching the dust bag. For this removal and attachment, ends of arms 131 and 132 remote from pistons 141 and 142 are provided with electromagnets, respectively. Control unit 73 controls replacing mechanism units 54A and 54B to turn on/off the electromagnets.

New and old dust bags 42 and 32 have surface portions for contact with arm 132, and new and old battery units 41 and 31 have surface portions for contact with arm 131. These surface portions are made of a magnetically attractable material such as iron. New and old dust bags 42 and 32 as well as new and old battery units 41 and 31 have surface portions for contact with self-propelled cleaner 2 when these are accommodated as cleaner-side unit 3 in self-propelled cleaner 2, and these surface portions are likewise made of a magnetically attractable material such as iron. Self-propelled cleaner 2 has a surface portion for contact with the battery unit and the dust bag accommodated as cleaner-side unit 3, and this surface portion is provided with an electromagnet (not shown). Control unit 62 energizes this electromagnet for magnetically attracting and fixing the battery unit and dust bag, which are accommodated as cleaner-side unit 3, in cleaner-side unit 3.

Each of unit replacing units 50A and 50B has a battery replacing unit for replacing old battery unit 31 on self-propelled cleaner 2 with new battery unit 41, as well as a dust replacing unit for replacing old dust bag 32 with new dust bag 42. When the battery replacing unit receives a unit removal instruction, it is activated to function as a battery removing unit for removing old battery unit 31 form self-propelled cleaner 2. When the battery replacing unit receives a unit attaching instruction, it is activated to function as a battery attaching unit for attaching new battery unit 41. These two functions are selectively activated under the control of control unit 73. When the dust storage unit replacing unit receives an instruction for removing the unit, it is activated to function as a dust storage unit removing unit for removing old dust bag 32 from self-propelled cleaner 2. When the dust storage unit replacing unit receives an instruction for attaching the unit, it is activated to function as a dust storage unit attaching unit for attaching new dust bag 42. These portions are selectively activated under the control of control unit 73.

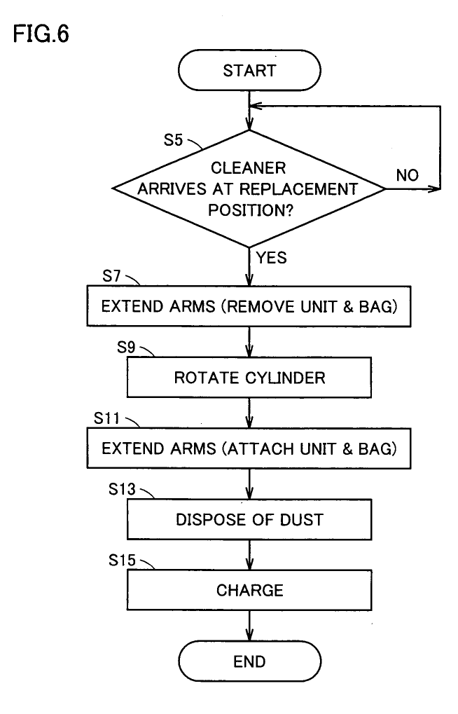

Description will now be given on a procedure illustrated in FIG. 6 for replacing the unit of self-propelled cleaner 2 on station 1.

First, in a step S5, when self-propelled cleaner 2 detects the timing of unit replacement, it starts movement toward station 1, and will arrive at a predetermined position for unit replacement by station 1. Thereby, arrival detecting unit 72 of station 1 detects the arrival of self-propelled cleaner 2, and provides a detection signal to control unit 73.

In a step S7, control unit 73 instructs the unit removal to replacing mechanism 54B in response to reception of the detection signal indicating arrival of self-propelled cleaner 2 from arrival detecting unit 72. In response to this instruction, the motor (not shown) of replacing mechanism 54B starts the rotary driving to protrude arms 131 and 132 outward from the casing of station 1 for removing the unit on the self-propelled cleaner side from the body of self-propelled cleaner 2.

More specifically, in accordance with rotation (rotation direction and rotation speed) of the motor of replacing mechanism 54B, pistons 141 and 142 in cylinders 121 and 122 extend or contract to move arms 131 and 132 connected to the ends thereof outward beyond or into the casing of station 1. For removing the unit on the self-propelled cleaner side, when arms 131 and 132 protrude, replacing mechanism 54A starts to energize the electromagnets on the ends of arms 131 and 132. Arms 131 and 132 thus protruded are located close to old battery unit 31 and old dust bag 32 of cleaner-side unit 3 on self-propelled cleaner 2, and the electromagnets pull them toward station 1. The pulling forces exceed the pulling force of the electromagnets arranged on cleaner-side unit 3 of self-propelled cleaner 2. Consequently, old battery unit 31 and old dust bag 32 are removed from self-propelled cleaner 2, and are pulled onto the electromagnets on arms 131 and 132 so that the removal of the unit is completed.

In a step S9, when replacing mechanism 54B detects that arms 131 and 132 magnetically hold old battery unit 31 and old dust bag 32, it provides a detection signal to control unit 73. This magnetic holding can be detected in response to increase in measured weights of arms 131 and 132.

In response to reception of the detection signal, control unit 73 provides a control signal to start rotation of turn-cylinder motor 71. In accordance with this rotation, cylinder 11 rotates in a direction of an arrow AR1 so that cylinders 121 and 122, which are attached to cylinder 11 and accommodate arms 131 and 132, respectively, move a predetermined angle in the horizontal direction of arrow AR1 in accordance with the rotation of cylinder 11. The direction and angle of this rotation are instructed by a control signal applied to turn-cylinder motor 71.

Cylinders 121 and 122 accommodating arms 131 and 132 rotate on concentric horizontal surfaces at predetermined heights from a floor surface bearing station 1, respectively. The centers of these horizontal planes match with vertical cylinder 11 extending from the floor. Although not shown in FIG. 3, station 1 is provided at its casing with grooves for guiding the rotation of cylinders 121 and 122 in the direction of arrow AR1. Therefore, when cylinders 121 and 122 rotate in accordance with the rotation of cylinder 11, cylinder 11 rotates, but the casing itself of station 1 does not rotate so that the position of dust storage unit 15 attached to the outer surface of the casing of station 1 does not change.

The predetermined angle of the rotation in the direction of arrow AR1 is determined so that cleaner-side unit 3 (old dust bag 32 and old battery unit 31) attached to arms 131 and 132 may move to the position immediately above dust storage unit 15, and station-side unit 4 (new battery unit 41 and new dust bag 42) may move to the position opposed to the attaching unit of cleaner-side unit 3 of self-propelled cleaner 2. This predetermined angle is determined in advance by experiments or the like.

When the rotation in the direction of arrow AR1 ends, control unit 73 instructs replacing mechanism 54A to attach the unit in a step S11 so that replacing mechanism 54A is controlled to protrude arms 131 and 132 of station-side unit 4 outward from the casing of station 1. Thereby, new battery unit 41 and new dust bag 42 attracted by the electromagnets on the ends of arms 131 and 132 are accommodated in cleaner-side unit 3 on self-propelled cleaner 2. In this accommodated state, replacing mechanism unit 54A deenergizes the electromagnets on arms 131 and 132 so that arms 131 and 132 release new battery unit 41 and new dust bag 42. Thereafter, pistons 141 and 142 retract arms 131 and 132 into the casing of station 1. New battery unit 41 and new dust bag 42 released from arms 131 and 132 are pulled by the electromagnets on the self-propelled cleaner side, and are accommodated as cleaner-side unit 3 so that the unit attaching operation is completed.

When self-propelled cleaner 2 accommodates new battery unit 41 and new dust bag 42 as cleaner-side unit 3 in the bag attaching operation, new battery unit 41 and new dust bag 42 are electromagnetically connected and fixed to the cleaner body. When a sensor (not shown) or the like detects the fixing of them, control unit 62 moves self-propelled cleaner 2 away from station 1 in a direction of an arrow AR2 in response to this detection so that self-propelled cleaner 2 starts the moving or cleaning operation with new battery unit 41 and new dust bag 42.

In a next step S13, station 1 operates to discharge the dust from old dust bag 32. More specifically, old battery unit 31 and old dust bag 32, which were removed from self-propelled cleaner 2 and are connected to arms 131 and 132 as described above, are already located immediately above dust storage unit 15 in accordance with the rotation in the direction of arrow AR1. When this rotation ends, a lid (not shown) provided at a lower surface (on the floor side) of old dust bag 32 mounted on mount unit 52B is opened by a mechanism operating according to rotation of dust discharging motor 51B under the control of control unit 73. When the lid opens, the dust or the like stored in old dust bag 32 fall through an opening formed at the top of dust storage unit 15 into dust storage unit 15, and is stored in dust storage unit 15.

A manner of discharging of the dust from old dust bag 32 into dust storage unit 15 is not restricted to the opening and closing of the lid at the bottom of old dust bag 32. For example, new dust bag 42 (old dust bag 32) may be provided with an opening for collecting the dust into the bag by suction. In this case, old dust bag 32 mounted on mount unit 52B may be rotated by a mechanism operating according to rotation of dust discharging motor 51B such that the opening for such dust suction may be opposed to the upper opening of dust storage unit 15.

In a next step S15, old battery unit 31 is charged. More specifically, charging unit 55B controlled by control unit 73 charges main battery 10 of old battery unit 31 mounted on mount unit 52B with a power supplied from a commercial power supply via plug 70. Charging unit 55B determines a remaining amount of battery power of old battery unit 31. When charging unit 55B detects that the remaining amount is at a predetermined level, charging unit 55B notifies control unit 73 of this to stop the charging operation. In response to this notification, control unit 73 determines that dust disposal of old dust bag 32 and refreshing of old battery unit 31 are completed. In this manner, station 1 changes old dust bag 32 and old battery unit 31 into new dust bag 42 and new battery unit 41, respectively, and thereby prepares the bag and unit for replacement with those for another self-propelled cleaner 2 or for next replacement with the same self-propelled cleaner 2. The charging of charging unit 55B (or charging unit 55A) can be performed in any one of non-contact and contact manners.

In the above structure, extensible arms 131 and 132 as well as the electromagnets are used for replacing the battery units and dust bags. However, the manner of replacing the battery unit is not restricted to this.

As shown in FIG. 3, the dust bag and the battery unit are aligned vertically to each other. Therefore, the horizontal planes of rotation of cylinders 121 and 122 caused by rotation of cylinder 11, which extends vertically from the floor, are concentric with each other, but are located at different heights from the floor surface, respectively. However, the dust bag and the battery unit may be horizontally aligned along the floor surface in contrast to the manner in FIG. 3. In this case, the horizontal planes of rotation of cylinders 121 and 122 caused by rotation of cylinder 11, which extends vertically from the floor, form circles concentric with cylinder 11.

In the above manner, the dust bag and the battery unit are replaced at the same time. However, even when the remaining amount of main battery 10 lowers to a level requiring replacement with new battery unit 41, dust bag 32 may contain no dust or only a small amount of dust. Therefore, such a structure and manner may be employed that old dust bag 32 is replaced manually, and only the replacement of battery units 31 and 41 is automatically performed on station 1 in the foregoing manner.

As described above, the charging or refreshing of main battery 10 of self-propelled cleaner 2 is achieved by the replacement of old battery unit 31 with new battery unit 41 on station 1. Therefore, self-propelled cleaner 2 must be in the non-operating state only for a short time required for replacement of the units, and the availability factor of self-propelled cleaner 2 is improved. Further, one station 1 may have a plurality of unit replacing units 50A each having new dust bag 42 and new battery unit 41, whereby the battery units and dust bags can be replaced with those in the plurality of self-propelled cleaners 2.

Although the present invention has been described and illustrated in detail, it is clearly understood that the same is by way of illustration and example only and is not to be taken by way of limitation, the spirit and scope of the present invention being limited only by the terms of the appended claims.

1. A station for a self-propelled robot including a moving unit for movement, wherein
said self-propelled robot further includes a removable battery unit for supplying an electric power to various portions in said self-propelled robot, and
said station comprises an arrival detecting unit detecting arrival of said self-propelled robot at said station, and
battery replacing means for replacing said battery unit of said self-propelled robot with a charged battery unit prepared in advanced when said arrival detecting unit detects arrival of the self-propelled robot.

2. The station for the self-propelled robot according to claim 1, wherein
said battery replacing means has a battery removing unit for removing said battery unit from said self-propelled robot located on said station,
a battery attaching unit attaching said charged battery unit to said self-propelled robot after said battery unit was removed, and
a battery replacement control unit selectively activating said battery removing unit and said battery attaching unit.

3. The station for the self-propelled robot according to claim 2, wherein
said battery replacing means further has:
a battery mount unit holding said battery unit, and
a charging unit charging said battery unit held by said battery mount unit; and
said battery mount unit holds said battery unit removed from said self-propelled robot by said battery removing unit, and
said battery attaching unit attaches said battery unit charged by said charging unit when being held by said battery mount unit to said self-propelled robot.

4. The station for the self-propelled robot according to claim 3, further comprising:
a battery replacing rotary unit rotating to rotate concentrically said plurality of battery replacing means on a first horizontal plane parallel to a floor surface bearing said station, wherein
said battery replacement control unit includes:
battery removal activating means for activating, as said battery removing unit, said battery replacing means included among said plurality of battery replacing means and opposed to the self-propelled robot located on said station when said self-propelled robot arrives at said station, and
battery attachment activating means for activating said battery attaching unit of said battery replacing means located in a position opposed to said self-propelled robot by rotation by said battery replacing rotary unit after said battery removal activating means activates said battery replacing means opposed to said self-propelled robot.

5. The station for the self-propelled robot according to claim 4, wherein
said self-propelled robot further includes:
a cleaning unit having a dust collecting function, and a removable dust storage unit storing the dust collected by said cleaning unit; and
said station further comprises dust storage unit replacing means for replacing said dust storage unit of said self-propelled robot located on said station with a cleaned dust storage unit prepared in advance.

6. The station for the self-propelled robot according to claim 5, wherein
said dust storage unit replacing means has:
a dust storage unit removing unit removing said dust storage unit from said self-propelled robot located on said station,
a dust storage unit attaching unit attaching said cleaned dust storage unit to said self-propelled robot after said dust storage unit was removed, and
a dust storage unit replacement control unit selectively activating said dust storage unit removing unit and said dust storage unit attaching unit.

7. The station for the self-propelled robot according to claim 6, wherein
said dust storage unit replacing means further has:
a dust storage unit mount unit holding said dust storage unit, and
a cleaning unit cleaning said dust storage unit held by said dust storage unit mount unit; and
said battery mount unit holds the battery unit removed from the self-propelled robot by the battery mount unit, and
said dust storage unit attaching unit attaches said dust storage unit previously held by said dust storage unit mount unit and already cleaned by said cleaning unit to said self-propelled robot.

8. The station for the self-propelled robot according to claim 7, further comprising:
a dust storage unit replacing rotary unit rotating to rotate concentrically said plurality of dust storage unit replacing means on a second horizontal plane parallel to a floor surface bearing said station, wherein
said dust storage unit replacement control unit includes:
dust storage unit removal activating means for activating, as said dust storage unit removing unit, said dust storage unit replacing means included among said plurality of dust storage unit replacing means and opposed to said self-propelled robot located on said station, and
dust storage unit attachment activating means for activating said dust storage unit attaching unit of said dust storage unit replacing means located in the position opposed to said self-propelled robot by rotation of said dust storage unit replacing rotary unit after said dust storage unit removal activating means activates said dust storage unit replacing means.

9. The station for the self-propelled robot according to claim 8, wherein
said first and second horizontal planes are different from each other.

10. The station for the self-propelled robot according to claim 9, wherein
the replacement of the battery unit by said battery replacing means is performed in parallel with the replacement of the dust storage unit by said dust storage unit replacing means.

11. The station for the self-propelled robot according to claim 8, wherein
said first horizontal plane is the same as said second horizontal plane.

12. The station for the self-propelled robot according to claim 11, wherein
the replacement of the battery unit by said battery replacing means is performed in parallel with the replacement of the dust storage unit by said dust storage unit replacing means.

13. The station for the self-propelled robot according to claim 1, further comprising:
a battery replacing rotary unit rotating to rotate concentrically the plurality of battery replacing means on a first horizontal plane parallel to a floor surface bearing said station, wherein
said battery replacement control unit includes:
battery removal activating means for activating, as said battery removing unit, said battery replacing means included among said plurality of battery replacing means and opposed to said self-propelled robot located on said station when said self-propelled robot arrives at said station, and
battery attachment activating means for activating said battery attaching unit of said battery replacing means located in the position opposed to said self-propelled robot by rotation of said battery replacing rotary unit after said battery removal activating means activates said battery replacing means opposed to said self-propelled robot.

14. The station for the self-propelled robot according to claim 1, wherein
said self-propelled robot further includes:
a cleaning unit having a dust collecting function, and
a removable dust storage unit storing the dust collected by said cleaning unit; and
said station further comprises dust storage unit replacing means for replacing said dust storage unit of said self-propelled robot located on said station with a cleaned dust storage unit prepared in advance.

15. The station for the self-propelled robot according to claim 14, wherein
the replacement of the battery unit by said battery replacing means is performed in parallel with the replacement of the dust storage unit by said dust storage unit replacing means.

16. The station for the self-propelled robot according to claim 14, wherein
said dust storage unit replacing means has:
a dust storage unit removing unit removing said dust storage unit from said self-propelled robot located on said station,
a dust storage unit attaching unit attaching said cleaned dust storage unit to said self-propelled robot after said dust storage unit was removed, and
a dust storage unit replacement control unit selectively activating said dust storage unit removing unit and said dust storage unit attaching unit.

17. The station for the self-propelled robot according to claim 16, wherein
said dust storage unit replacing means further has:
a dust storage unit mount unit holding said dust storage unit, and
a cleaning unit cleaning said dust storage unit held by said dust storage unit mount unit; and
said battery mount unit holds the battery unit removed from the self-propelled robot by the battery mount unit, and
said dust storage unit attaching unit attaches said dust storage unit previously held by said dust storage unit mount unit and already cleaned by said cleaning unit to said self-propelled robot.

18. The station for the self-propelled robot according to claim 17, further comprising:
a dust storage unit replacing rotary unit rotating to rotate concentrically said plurality of dust storage unit replacing means on a second horizontal plane parallel to a floor surface bearing said station, wherein
said dust storage unit replacement control unit includes:
dust storage unit removal activating means for activating, as said dust storage unit removing unit, said dust storage unit replacing means included among said plurality of dust storage unit replacing means and opposed to said self-propelled robot located on said station, and
dust storage unit attachment activating means for activating said dust storage unit attaching unit of said dust storage unit replacing means located in the position opposed to said self-propelled robot by rotation of said dust storage unit replacing rotary unit after said dust storage unit removal activating means activates said dust storage unit replacing means.

19. The station for the self-propelled robot according to claim 18, wherein
said first and second horizontal planes are different from each other.

20. The station for the self-propelled robot according to claim 18, wherein
said first horizontal plane is the same as said second horizontal plane.
